(19) United States
(12) Patent Application Publication
(10) Pub. No.: US 2025/0240683 A1
(43) Pub. Date: Jul. 24, 2025

(54) REPORTING CELL (RE)SELECTION MEASUREMENTS

(71) Applicant: Samsung Electronics Co., Ltd., Suwon-si (KR)

(72) Inventor: Anil Agiwal, McKinney, TX (US)

(21) Appl. No.: 19/014,172

(22) Filed: Jan. 8, 2025

Related U.S. Application Data
(60) Provisional application No. 63/624,609, filed on Jan. 24, 2024.

(51) Int. Cl. H04W 36/00; H04W 76/27

(52) U.S. Cl. CPC H04W 36/0088; H04W 76/27

(57) ABSTRACT

Methods and apparatuses for reporting cell (re) selection measurements. A user equipment (UE) includes a processor, and a transceiver operatively coupled to the processor. The transceiver is configured to receive, from a base station (BS), a first message including a request for cell (re) selection measurements, and in response to receipt of the first message, transmit to the BS, a second message including the cell (re) selection measurements.

### CROSS-REFERENCE TO RELATED APPLICATION(S) AND CLAIM OF PRIORITY

This application claims priority under 35 U.S.C. § 119 (e) to U.S. Provisional Patent Application No. 63/624,609 filed on Jan. 24, 2024. The above-identified provisional patent application is hereby incorporated by reference in its entirety.

### TECHNICAL FIELD

This disclosure relates generally to wireless networks. More specifically, this disclosure relates to reporting cell (re) selection measurements.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for reporting cell (re) selection measurements.

In one embodiment, a user equipment (UE) is provided. The UE includes a processor, and a transceiver operatively coupled to the processor. The transceiver is configured to receive, from a base station (BS), a first message including a request for cell (re) selection measurements, and in response to receipt of the first message, transmit to the BS, a second message including the cell (re) selection measurements.

In another embodiment, a BS is provided. The BS includes a processor, and a transceiver operatively coupled to the processor. The transceiver is configured to transmit, to a UE, a first message including a request for cell (re) selection measurements, and receive, from the UE, a second message including the cell (re) selection measurements.

In yet another embodiment, a method of operating a UE is provided. The method includes receiving, from a BS, a first message including a request for cell (re) selection measurements. The method also includes in response to receipt of the first message, transmitting to the BS, a second message including the cell (re) selection measurements.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example signal flow between a UE and a gNB for reporting of cell (re) selection measurements performed by the UE in the RRC_IDLE/RRC_INACTIVE state to the gNB according to embodiments of the present disclosure;

FIG. 5 illustrates another example signal flow between a UE and a gNB for reporting of cell (re) selection measurements according to embodiments of the present disclosure;

FIG. 6 illustrates another example signal flow between a UE and a gNB for reporting of cell (re) selection measurements according to embodiments of the present disclosure;

FIG. 7 illustrates another example signal flow between a UE and a gNB for reporting of cell (re) selection measurements according to embodiments of the present disclosure; and

FIG. 8 illustrates an example method for reporting cell (re) selection measurements according to embodiments of the present disclosure.

### DETAILED DESCRIPTION

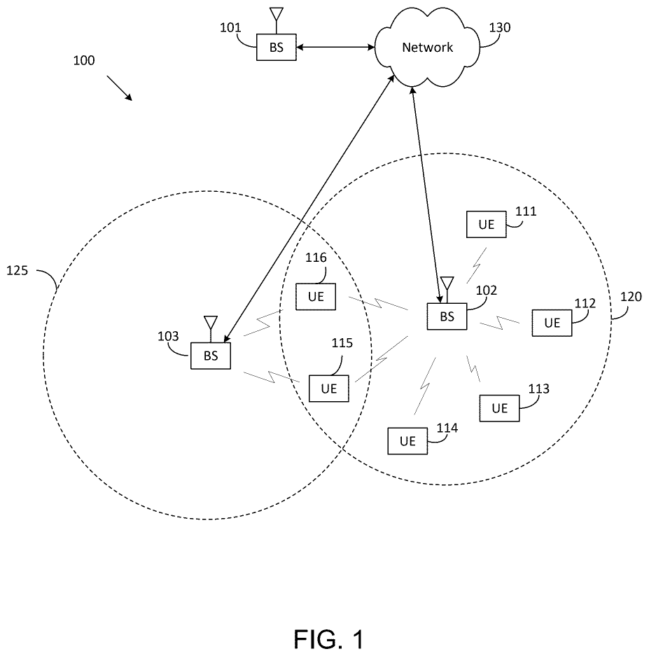

FIGS. 1 through 8, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for reporting cell (re) selection measurements. In certain embodiments, one or more of the gNBs 101-103 includes circuitry, programing, or a combination thereof, to support reporting cell (re) selection measurements in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

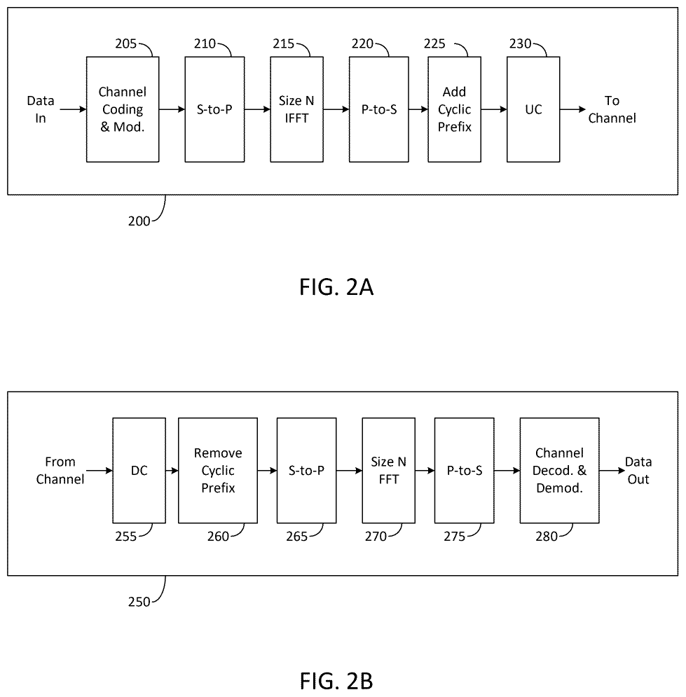

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support reporting cell (re) selection measurements as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

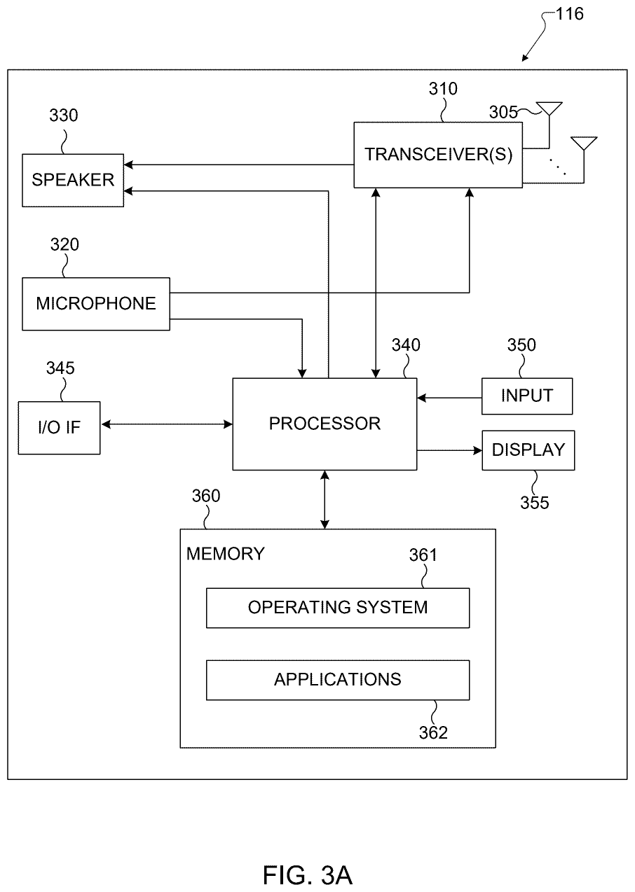

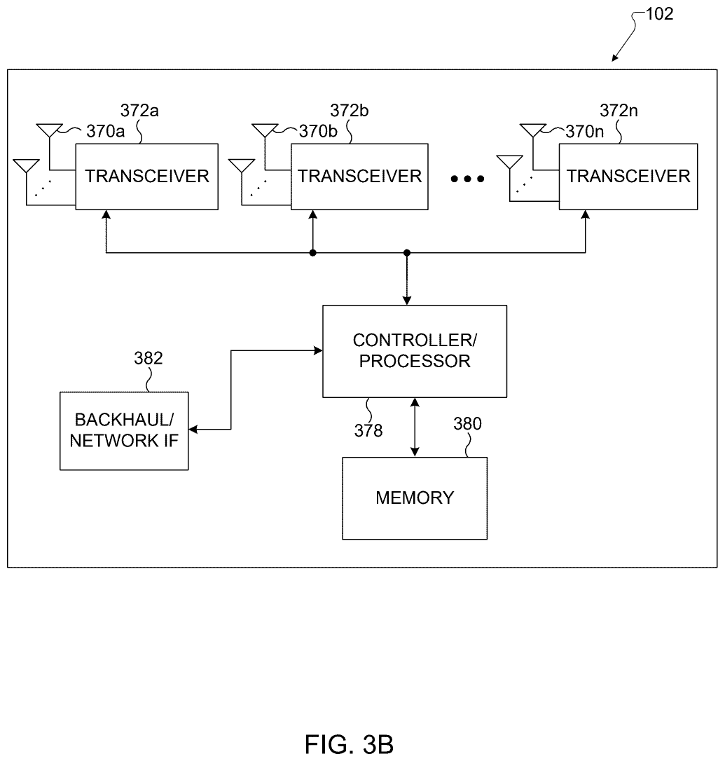

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for reporting cell (re) selection measurements as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support reporting cell (re) selection measurements as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs communicate with each other using Beamforming. Beamforming techniques are used to mitigate propagation path losses and to increase the propagation distance for communication at higher frequency bands. Beamforming enhances the transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred to as a transmit (TX) beam. A wireless communication system operating at high frequency uses a plurality of narrow TX beams to transmit signals in the cell, as each narrow TX beam provides coverage to a part of cell. The narrower the TX beam, the higher the antenna gain and hence the larger the propagation distance of a signal transmitted using beamforming. A receiver can also generate a plurality of receive (RX) beam patterns of different directions. Each of these receive patterns can be also referred to as a receive (RX) beam.

The next generation wireless communication system (e.g., 5G, beyond 5G, 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising Special Cell(s) (SpCell[s]) and all secondary cells (SCells). In NR the term Master Cell Group (MCG) refers to a group of serving cells associated with the Master Node, comprising the primacy cell (PCell) and optionally one or more SCells. In NR the term Secondary Cell Group (SCG) refers to a group of serving cells associated with the Secondary Node, comprising the Primary SCG Cell (PSCell) and optionally one or more SCells. In NR PCell (primary cell) refers to a serving cell in the MCG, operating on the primary frequency, in which the UE either performs the initial connection establishment procedure or initiates the connection re-establishment procedure. In NR for a UE configured with CA, an SCell is a cell providing additional radio resources on top of the SpCell. Primary SCG Cell (PSCell) refers to a serving cell in an SCG in which the UE performs random access when performing the Reconfiguration with Sync procedure. For Dual Connectivity operation the term SpCell refers to the PCell of the MCG or the PSCell of the SCG, otherwise the term SpCell refers to the PCell.

In the next generation wireless communication system (e.g., 5G, beyond 5G, 6G), a node B (gNB) or base station in cell broadcast Synchronization Signal and PBCH block (SSB) comprises primary and secondary synchronization signals (PSS, SSS) and system information. System information includes common parameters needed to communicate in the cell. In the fifth generation wireless communication system (also referred to as next generation radio or NR), System Information (SI) is divided into the master information block (MIB) and a number of system information blocks (SIBs), wherein the MIB is transmitted on the broadcast channel (BCH) with a periodicity of 80 ms and repetitions made within 80 ms and the MIB includes parameters that are needed to acquire SIB1 from the cell. The SIB1 is transmitted on the DL-SCH with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand and, in that case, the configuration needed by the UE to perform the SI request. SIB1 is a cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with the same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as an SI area, which comprises one or several cells and is identified by systemInformationArealD. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using the RR (Reconfiguration message (e.g., if the UE has an active bandwidth part (BWP) with no common search space configured to monitor system information, paging, or upon request from the UE). In the RRC_CONNECTED state, the UE acquires the SIB(s) only from the PCell. For PSCell and SCells, the network provides the required SI by dedicated signaling (i.e., within an RR (Reconfiguration message). Nevertheless, the UE acquires the MIB of the PSCell to get system frame number (SFN) timing of the SCG (which may be different from the MCG). Upon change of relevant SI for an SCell, the network releases and adds the concerned SCell. For the PSCell, the SI can only be changed with Reconfiguration with Sync.

In the next generation wireless communication system (e.g., 5G, beyond 5G, 6G), the Physical Downlink Control Channel (PDCCH) is used to schedule DL transmissions on the physical downlink shared channel (PDSCH) and UL transmissions on the physical uplink shared channel (PUSCH), where the Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, the PDCCH can be used to for: activation and deactivation of a configured PUSCH transmission with a configured grant; activation and deactivation of a PDSCH semi-persistent transmission; notifying one or more UEs of the slot format; notifying one or more UEs of the PRB(s) and OFDM symbol(s) where the UE may assume no transmission is intended for the UE; transmission of TPC commands for the physical uplink control channel (PUCCH) and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of physical resource blocks (PRBs) with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating different numbers of CCEs. Interleaved and non-interleaved CCE-to-REG mapping are supported in a CORESET. Polar coding is used for the PDCCH. Each resource element group carrying the PDCCH carries its own demodulation reference signal (DMRS). Quadrature phase shift keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. The search space identifier is unique amongst the BWPs of a serving cell. An identifier of the search space configuration to be used for a specific purpose such as paging reception, SI reception, random access response reception is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. A search space configuration includes the identifier of the CORESET configuration associated with it. A list of CORESET configurations are signaled by the gNB for each configured BWP of the serving cell, wherein each CORESET configuration is uniquely identified by a CORESET identifier. A CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (the DL TX beam is QCLed with the SSB/CSI RS of the TCI state) used by the gNB for transmission of the PDCCH in the PDCCH monitoring occasions of a search space.

In the next generation wireless communication system (e.g., 5G, beyond 5G, 6G) bandwidth adaptation (BA) is supported. With BA, the receive and transmit bandwidth of a UE need not be as large as the bandwidth of the cell and can be adjusted: the width can be ordered to change (e.g., to shrink during periods of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., it does not have to monitor the PDCCH on the entire DL frequency of the serving cell). In an RRC connected state, a UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-InactivityTimer, by RRC signaling, or by the MAC entity itself upon initiation of a Random Access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of a BWP inactivity timer, the UE switches the active DL BWP to the default DL BWP or initial DL BWP (if a default DL BWP is not configured).

In the next generation wireless communication system (e.g., 5G, beyond 5G, 6G), The network may request the UE to measure NR and/or E-UTRA carriers in the RRC_IDLE or RRC_INACTIVE state via system information or via a dedicated measurement configuration in RRCRelease. If the UE was configured to perform measurements of NR and/or E-UTRA carriers while in the RRC_IDLE or in the RRC_INACTIVE state, it may provide an indication of the availability of corresponding measurement results to the gNB in the RRCSetupComplete message. The network may request the UE to report those measurements after security activation. The request for the measurements can be sent by the network immediately after transmitting the Security Mode Command (i.e., before the reception of the Security Mode Complete from the UE).

If the UE was configured to perform measurements of NR and/or E-UTRA carriers while in the RRC_INACTIVE state, the gNB can request the UE to provide corresponding measurement results in the RRCResume message and then the UE can include the available measurement results in the RRCResumeComplete message. Alternatively, the UE may provide an indication of the availability of the measurement results to the gNB in the RRCResumeComplete message and the gNB can then request the UE to provide these measurement results.

A UE may not support measurements of NR and/or E-UTRA carriers in the RRC_IDLE or RRC_INACTIVE state wherein NR and/or E-UTRA carriers to be measured are configured by the network in system information or dedicated signaling. These measurements are in addition to measurements which the UE performs in the RRC_IDLE or RRC_INACTIVE state for cell selection/reselection. The measurements performed by the UE in the RRC_IDLE or RRC_INACTIVE states for cell selection/reselection can be reported to network. These measurements can help the network to configure carrier aggregation or dual connectivity in the RRC_CONNECTED state.

Various embodiments of the present disclosure address issues related to reporting cell selection/reselection measurements, such as new UE capabilities (to distinguish whether the UE supports cell selection/reselection measurement reporting or the UE supports measurements configured by network in RRC_IDLE or RRC_INACTIVE), validity or what to report for cell reselection measurements, signaling procedure for reporting cell selection/reselection measurements, etc.

If a UE supports measurements of NR and/or E-UTRA and/or 6G carriers in the RRC_IDLE or RRC_INACTIVE state wherein the NR and/or E-UTRA and/or 6G carriers to be measured and reported (upon network request) are configured by the network (e.g., a base station or gNB) in system information and/or dedicated signaling, the UE indicates its support using the parameters idleInactiveNR-MeasReport (set to TRUE) and idleInactiveNR-MeasBeamReport (set to TRUE) in a UE capability information message. This message is transmitted by the UE in the RRC_CONNECTED state. idleInactiveNR-MeasReport indicates whether the UE supports configuration of NR SSB measurements in the RRC_IDLE/RRC_INACTIVE state and reporting of the corresponding results upon network request. idleInactiveNR-MeasBeamReport indicates whether the UE supports beam level measurements in the RRC_IDLE/RRC_INACTIVE state and reporting of the corresponding beam measurement results upon network request. idleInactiveEUTRA-MeasReport, indicates whether the UE supports configuration of E-UTRA measurements in the RRC_IDLE/RRC_INACTIVE state and reporting of the corresponding results upon network request. idleInactive6G-MeasReport, indicates whether the UE supports configuration of 6G measurements in the RRC_IDLE/RRC_INACTIVE state and reporting of the corresponding results upon network request.

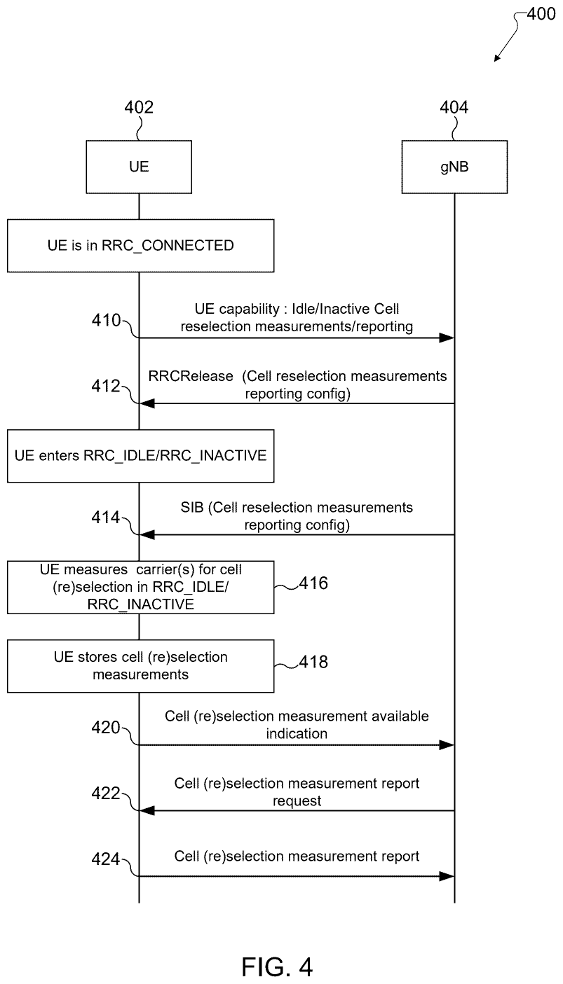

FIG. 4 illustrates an example signal flow 400 between a UE and a gNB for reporting of cell (re) selection measurements performed by the UE in the RRC_IDLE/RRC_INACTIVE state to the gNB according to embodiments of the present disclosure. An embodiment of the signal flow illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments for reporting of cell (re) selection measurements performed by a UE in the RRC_IDLE/RRC_INACTIVE state to a gNB could be used without departing from the scope of this disclosure.

In the example of FIG. 4, the signaling is performed between a UE 402 and a network (i.e., base station or gNB) 404. In some embodiments, at step 410, UE 402 indicates its support for reporting to the network 404, cell selection/reselection measurements (cell level, beam level) performed by UE 402 in the RRC_IDLE or RRC_INACTIVE state in a UE capability information message. This message is transmitted by UE 402 in the RRC_CONNECTED state.

In some embodiments, UE 402 may indicate that it supports reporting (upon network request) of cell selection/reselection measurements of NR by including the parameter idleInactiveNR-CellReselectionMeasReport in the UE capability information message. In some embodiments, UE 402 may indicate that it supports reporting of cell selection/reselection beam measurements by including the parameter idleInactiveNR-CellReselectionMeasBeamReport in the UE capability information message. In some embodiments, UE 402 may indicate that it supports reporting (upon network request) of cell selection/reselection measurements of EUTRA by including the parameter idleInactiveEUTRA-CellReselectionMeasReport in the UE capability information message. In some embodiments, UE 402 may indicate that it supports reporting (upon network request) of cell selection/reselection measurements of 6G by including the parameter idleInactive6G-CellReselectionMeasReport in the UE capability information message.

In some embodiments, UE 402 may indicate that it supports reporting of cell selection/reselection cell level and beam level measurements of NR by including the parameter idleInactiveNR-CellReselectionMeasReport in the UE capability information message. In some embodiments, UE 402 may indicate that it supports reporting of cell selection/reselection cell level and beam level measurements of 6G by including the parameter idleInactive6G-CellReselectionMeasReport in the UE capability information message.

The advantage of these new UE capabilities is that network 404 can distinguish between two types of RRC_IDLE/RRC_INACTIVE measurements and reporting: 1) measurements of NR and/or E-UTRA and/or 6G carriers in RRC_IDLE or RRC_INACTIVE and reporting (upon network request) of the measurements, wherein the NR and/or E-UTRA and/or 6G carriers to be measured are configured by network 404 in system information or dedicated signaling; 2) reporting (upon network request) of cell selection/reselection measurements of NR and/or E-UTRA and/or 6G carriers performed by UE 402 in the RRC_IDLE or RRC_INACTIVE state.

Upon receiving an RRCRelease message at step 412 while in the RRC_CONNECTED state, UE 402 enters the RRC_IDLE/RRC_INACTIVE state. In some embodiments, network (i.e., base station or gNB) 404 can signal in system information (e.g., a SIB at step 414) or dedicated signaling (e.g., an RRC message such as the RRCRelease message of step 412) the following for reporting cell reselection measurements:
Measurement quantity to report (RSRP, RSRQ or both)
Quality threshold for reporting cell level measurement (i.e., if the cell level measurement quality is above a threshold, UE 402 stores and/or UE 402 may include this measurement in the report)
Quality threshold for reporting beam level measurements (i.e., if the beam level measurement quality is above a threshold, UE 402 stores and/or UE 402 may include this measurement in the report)
Maximum number of beams to report
Maximum number of carrier/cells to report

In some embodiments, network (i.e., base station or gNB) 404 can signal in system information (e.g., a SIB at step 414) or dedicated signaling (e.g., an RRC message such as the RRCRelease message of step 412) that network 404 supports cell (re) selection measurements/measurement reporting.

At step 416, while in an RRC_IDLE/RRC_INACTIVE state, UE 402 measures carriers (frequencies) for cell (re) selection, and stores the measurements at step 418. In some embodiments, UE 402 may perform step 418 if UE 402 has received an indication in system information (e.g., a SIB at step 414) or dedicated signaling (e.g., an RRC message such as the RRCRelease message of step 412) that the cell supports cell (re) selection measurements/measurement reporting. In some embodiments, UE 402 may perform step 418 if UE 402 has received a configuration of reporting cell (re) selection measurements in system information (e.g., a SIB at step 414) or dedicated signaling (e.g., an RRC message such as the RRCRelease message of step 412). In some embodiments, for the carriers (frequencies) for which UE 402 supports CA or DC together with a serving carrier, while camped on a serving carrier, if UE 402 has measured carriers (frequencies) as part of cell reselection, for which UE 402 supports CA or DC together with serving carrier, UE 402 stores the measurements. In some embodiments, UE 402 stores the measurements for a defined time (e.g., a timer can be configured by network 404). After this time, UE 402 discards the stored measurements. For example, UE 402 may measure a carrier at time T. The timer value is T1. So, UE 402 will store the measurements until T+T1.

In some embodiments, at step 420, UE 402 may indicate to network (i.e., base station or gNB) 404 that cell (re) selection measurements are available.

In some embodiments, at step 422, network (i.e., base station or gNB) 404 may send a request for a cell (re) selection measurements report. For example, network (i.e., base station or gNB) 404 may send this request if UE 402 has indicated availability of cell (re) selection measurements. Alternately, network (i.e., base station or gNB) 404 may send this request even if UE 402 has not indicated availability of cell (re) selection measurements.

In some embodiments, upon receiving a request from network (i.e., base station or gNB) 404 for cell reselection measurement, at step 424 UE 402 reports the cell reselection measurements to network (i.e., base station or gNB) 404. In some embodiments, UE 402 only reports the cell reselection measurement of carriers (frequencies) for which UE 402 supports CA or DC together with a serving carrier.

Although FIG. 4 illustrates one example signal flow 400 between a UE and a gNB for reporting of cell (re) selection measurements performed by the UE in the RRC_IDLE/RRC_INACTIVE state to the gNB, various changes may be made to FIG. 4. For example, while shown as a series of steps, various steps in FIG. 4 could overlap, occur in parallel, occur in a different order, occur any number of times, be omitted, or replaced by other steps.

In some embodiments of a request and/or response for a cell (re) selection measurement report, a new indication (cellReselectionMeasurementReq) can be included in a RRCResume message, RRCSetup message, and/or UE information request. In some embodiments, the Indication can be common for all RATs (e.g., E-UTRA, NR, 6G etc). In some embodiments, the Indication can be separate per RAT (e.g., E-UTRA, NR, 6G).

In some embodiments of a request and/or response for a cell (re) selection measurement report, a stored cell reselection measurements report (cellReselectionMeasurement) can be included in a RRCSetupComplete message, RRCResumeComplete message, and/or UE information response. In some embodiments, the report can be common for all RATs (e.g., E-UTRA, NR, 6G etc). In some embodiments, the report can be separate per RAT (e.g., E-UTRA, NR, 6G).

In some embodiments of a request and/or response for a cell (re) selection measurement report, a stored cell reselection measurements report availability (cellReselectionMeasAvailable) can be indicated in a RRCSetupComplete message and/or RRCResumeComplete message. In some embodiments, the availability indication can be common for all RATs (e.g., E-UTRA, NR, 6G etc). In some embodiments, the availability indication can be separate per RAT (e.g., E-UTRA, NR, 6G).

In some embodiments of a request and/or response for a cell (re) selection measurement report, if a camped cell supports cell reselection measurements reporting, UE 402 can indicate availability of such measurements in an RRCSetupComplete message, RRCResumeComplete message, RRCSetupRequest message, and/or RRCConnectionRequest message. In some embodiments, the availability indication can be common for all RATs (e.g., E-UTRA, NR, 6G etc). In some embodiments, the availability indication can be separate per RAT (e.g., E-UTRA, NR, 6G).

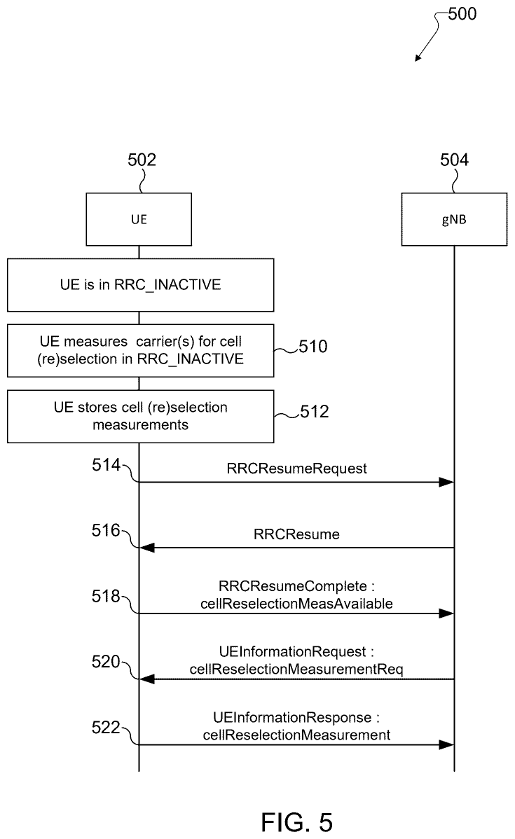

FIG. 5 illustrates another example signal flow 500 between a UE and a gNB for reporting of cell (re) selection measurements according to embodiments of the present disclosure. An embodiment of the signal flow illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for reporting of cell (re) selection measurements could be used without departing from the scope of this disclosure.

In the example of FIG. 5, the signaling is performed between a UE 502 and a network (i.e., base station or gNB) 504.

While UE 502 is in an RRC_INACTIVE state, at step 510, UE 502 measures carrier(s) for cell (re) selection, and UE 502 stores cell (re) selection measurements at step 512.

RRC connection resumption is initiated at step 514, where UE 502 sends an RRC Resume request to network (i.e., base station or gNB) 504.

At step 516, UE 502 receives an RRC Resume message from network (i.e., base station or gNB) 504 and enters an RRC_CONNECTED state.

At step 518, UE 502 then sends an RRCResumeComplete message to network (i.e., base station or gNB) 504. Availability of cell (re) selection measurements is indicated in the RRCResumeComplete message.

At step 520, network (i.e., base station or gNB) 504 sends UE 502 an information request, wherein the message includes an indication (cellReselectionMeasurementReq) for the cell (re) selection measurements. The information request may be received by UE 502 in an RRC_CONNECTED state.

At step 522, UE 502 sends a UE information response including the cell (re) selection measurements to network (i.e., base station or gNB) 504. The information response may be transmitted by UE 502 in an RRC_CONNECTED state.

Although FIG. 5 illustrates one example signal flow 500 between a UE and a gNB for reporting of cell (re) selection measurements, various changes may be made to FIG. 5. For example, while shown as a series of steps, various steps in FIG. 5 could overlap, occur in parallel, occur in a different order, occur any number of times, be omitted, or replaced by other steps.

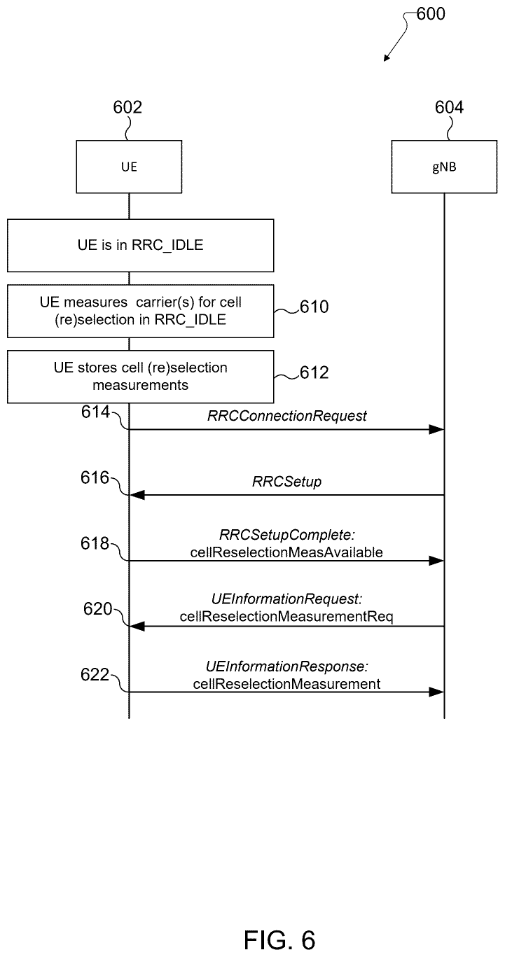

FIG. 6 illustrates another example signal flow 600 between a UE and a gNB for reporting of cell (re) selection measurements according to embodiments of the present disclosure. An embodiment of the signal flow illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments for reporting of cell (re) selection measurements could be used without departing from the scope of this disclosure.

In the example of FIG. 6, the signaling is performed between a UE 602 and a network (i.e., base station or gNB) 604.

While UE 602 is in an RRC_IDLE state, at step 610, UE 602 measures carrier(s) for cell (re) selection, and UE 502 stores cell (re) selection measurements at step 612.

RRC connection setup is initiated at step 614, where UE 602 sends an RRC connection request to network (i.e., base station or gNB) 604.

At step 616, UE 602 receives an RRC setup message from network (i.e., base station or gNB) 604 and enters an RRC_CONNECTED state.

At step 618, UE 602 then sends an RRCSetupComplete message to network (i.e., base station or gNB) 604. Availability of cell (re) selection measurements is indicated in the RRCSetupComplete message.

At step 620, network (i.e., base station or gNB) 604 sends UE 602 an information request, wherein the message includes an indication (cellReselectionMeasurementReq) for the cell (re) selection measurements. The information request may be received by UE 502 in an RRC_CONNECTED state.

At step 622, UE 502 sends a UE information response including the cell (re) selection measurements to network (i.e., base station or gNB) 604. The information response may be transmitted by UE 502 in an RRC_CONNECTED state.

Although FIG. 6 illustrates one example signal flow 600 between a UE and a gNB for reporting of cell (re) selection measurements, various changes may be made to FIG. 6. For example, while shown as a series of steps, various steps in FIG. 6 could overlap, occur in parallel, occur in a different order, occur any number of times, be omitted, or replaced by other steps.

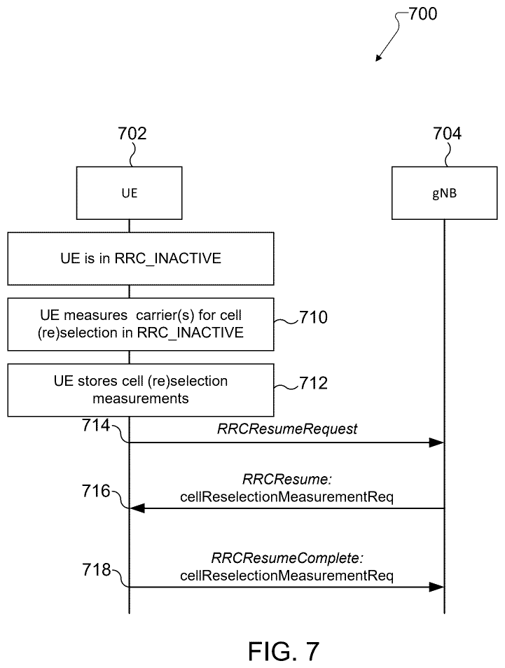

FIG. 7 illustrates another example signal flow 700 between a UE and a gNB for reporting of cell (re) selection measurements according to embodiments of the present disclosure. An embodiment of the signal flow illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments for reporting of cell (re) selection measurements could be used without departing from the scope of this disclosure.

In the example of FIG. 7, the signaling is performed between a UE 702 and a network (i.e., base station or gNB) 704.

While UE 702 is in an RRC_INACTIVE state, at step 710, UE 702 measures carrier(s) for cell (re) selection, and UE 702 stores cell (re) selection measurements at step 712.

RRC connection resumption is initiated at step 714, where UE 702 sends an RRC Resume request to network (i.e., base station or gNB) 704.

At step 716, UE 702 receives an RRC Resume message from network (i.e., base station or gNB) 704, wherein the message includes an indication (cellReselectionMeasurementReq) for cell (re) selection measurements.

At step 718, UE 702 then sends an RRCResumeComplete message to network (i.e., base station or gNB) 704 including the cell (re) selection measurements.

Although FIG. 7 illustrates one example signal flow 700 between a UE and a gNB for reporting of cell (re) selection measurements, various changes may be made to FIG. 7. For example, while shown as a series of steps, various steps in FIG. 7 could overlap, occur in parallel, occur in a different order, occur any number of times, be omitted, or replaced by other steps.

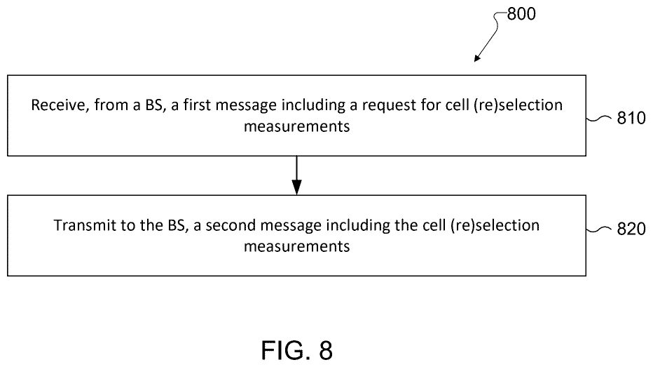

FIG. 8 illustrates an example method for reporting cell (re) selection measurements 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a method for reporting cell (re) selection measurements could be used without departing from the scope of this disclosure.

In the example of FIG. 8, method 800 begins at step 810. At step 810, a UE (such as UE 116 of FIG. 1) receives, from a BS (such as BS 102 of FIG. 1), a first message including a request for cell (re) selection measurements.

At step 820, in response to receipt of the first message, the UE transmits to the BS, a second message including the cell (re) selection measurements.

In some embodiments, the UE receives the first message while the UE is in an RRC inactive state, the first message is an RRC resume message, and the second message is an RRC resume complete message.

In some embodiments, the UE transmits, to the BS a third message indicating an availability of cell (re) selection measurements, and receives the first message from the BE in response to transmission of the third message. In some embodiments, the third message is a radio resource control (RRC) resume complete message, the first message is a UE information request message, and the second message is a UE information response message. In some embodiments, the third message is a radio resource control (RRC) setup complete message, the first message is a UE information request message, and the second message is a UE information response message.

In some embodiments, while the UE is in one of a radio resource control (RRC) inactive state or an RRC idle state, the UE performs at least one cell (re) selection measurement, and stores at least one result of the at least one cell (re) selection measurement in a memory of the UE. In some embodiments, the UE receives a third message including a validity time for the at least one result, and includes the at least one result in the second message based on the validity time.

Although FIG. 8 illustrates one example method for reporting cell (re) selection measurements 800, various changes may be made to FIG. 8. For example, while shown as a series of steps, various steps in FIG. 8 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a processor; and
a transceiver operatively coupled to the processor, the transceiver configured to:
receive, from a base station (BS), a first message including a request for cell (re) selection measurements; and
in response to receipt of the first message, transmit to the BS, a second message including the cell (re) selection measurements.

2. The UE of claim 1, wherein:
the transceiver is further configured to receive the first message while the UE is in a radio resource control (RRC) inactive state;
the first message is an RRC resume message; and
the second message is an RRC resume complete message.

3. The UE of claim 1, wherein the transceiver is further configured to:
transmit, to the BS, a third message indicating an availability of cell (re) selection measurements; and
in response to transmission of the third message, receive from the BS, the first message.

4. The UE of claim 3, wherein:
the third message is a radio resource control (RRC) resume complete message; and
the first message is a UE information request message; and
the second message is a UE information response message.

5. The UE of claim 3, wherein:
the third message is a radio resource control (RRC) setup complete message; and
the first message is a UE information request message; and
the second message is a UE information response message.

6. The UE of claim 1, wherein the processor is configured to:
while the UE is in one of a radio resource control (RRC) inactive state or an RRC idle state, cause the UE to perform at least one cell (re) selection measurement; and
store at least one result of the at least one cell (re) selection measurement in a memory of the UE.

7. The UE of claim 6, wherein:
the transceiver is further configured to receive a third message including a validity time for the at least one result; and
the processor is further configured to include the at least one result in the second message based on the validity time.

8. A base station (BS) comprising:
a processor; and
a transceiver operatively coupled to the processor, the transceiver configured to:
transmit, to a user equipment (UE), a first message including a request for cell (re) selection measurements; and
receive, from the UE, a second message including the cell (re) selection measurements.

9. The BS of claim 8, wherein:
the transceiver is further configured to transmit the first message while the UE is in a radio resource control (RRC) inactive state;
the first message is an RRC resume message; and
the second message is an RRC resume complete message.

10. The BS of claim 8, wherein the transceiver is further configured to:
receiving, from the UE, a third message indicating an availability of cell (re) selection measurements; and
in response to receipt of the third message, transmit, to the UE, the first message.

11. The BS of claim 10, wherein:
the third message is a radio resource control (RRC) resume complete message; and
the first message is a UE information request message; and
the second message is a UE information response message.

12. The BS of claim 10, wherein:
the third message is a radio resource control (RRC) setup complete message; and
the first message is a UE information request message; and
the second message is a UE information response message.

13. The BS of claim 10, wherein the transceiver is further configured to transmit, to the UE, a third message including a validity time for at least one cell (re) selection measurement result.

14. A method of operating a user equipment (UE), the method comprising:
receiving, from a base station (BS), a first message including a request for cell (re) selection measurements; and
in response to receipt of the first message, transmitting to the BS, a second message including the cell (re) selection measurements.

15. The method of claim 14, further comprising receiving the first message while the UE is in a radio resource control (RRC) inactive state, wherein:
the first message is an RRC resume message; and
the second message is an RRC resume complete message.

16. The method of claim 14, further comprising:
transmitting, to the BS, a third message indicating an availability of cell (re) selection measurements; and
in response to transmission of the third message, receiving from the BS, the first message.

17. The method of claim 16, wherein:
the third message is a radio resource control (RRC) resume complete message;
the first message is a UE information request message; and
the second message is a UE information response message.

18. The method of claim 16, wherein:
the third message is a radio resource control (RRC) setup complete message; and
the first message is a UE information request message; and
the second message is a UE information response message.

19. The method of claim 14, further comprising:
while the UE is in one of a radio resource control (RRC) inactive state or an RRC idle state, performing at least one cell (re) selection measurement; and
storing at least one result of the at least one cell (re) selection measurement in a memory of the UE.

20. The method of claim 19, further comprising:
receiving a third message including a validity time for the at least one result; and
including the at least one result in the second message based on the validity time.
